(19) United States
(12) Patent Application Publication
(10) Pub. No.: US 2004/0029683 A1
(43) Pub. Date: Feb. 12, 2004

(54) Drive means for motor vehicles

(76) Inventor: Marcus Steen, Angered (SE)

Correspondence Address: YOUNG & THOMPSON, 745 SOUTH 23RD STREET 2ND FLOOR, ARLINGTON, VA, 22202

(21) Appl. No.: 10/296,981

(22) PCT Filed: May 30, 2001
(86) PCT No.: PCT/SE01/01210

(30) Foreign Application Priority Data
May 30, 2000 (SE) 0002012-3

(51) Int. Cl. B60K 41/04

(52) U.S. Cl. 477/115

(57) ABSTRACT

Drive elements for motor vehicles, include an internal combustion engine (1) and an automated multi-stage gearbox (9). Shifting is effected by compressed-air cylinders controlled by a control computer (45) which is programmed so as, in the event of input signals indicating vehicle speed and zero throttle, to put the currently engaged gear in the neutral position, and, in the event of an input signal indicating throttle, first to speed-control the engine to a speed which makes possible engagement of the gear, and then to give a signal to engage the gear. The engine is coupled to an electric machine (50) which is controlled by the control computer in such a manner that, in the event of the engine stopping with the freewheel function activated, the electric machine first controls the engine to a speed which makes possible engagement of a gear, and then gives a signal to engage the gear.

The present invention relates to a drive means for motor vehicles, comprising an internal combustion engine and, connected to the crankshaft of the engine via a clutch, an input shaft of a multi-stage gearbox which has at least one intermediate shaft which is mounted in a casing and has at least one gear wheel in engagement with a gear wheel on the input shaft, a main shaft, mounted in the casing, with gear wheels which engage with gear wheels on the intermediate shaft, at least one gear wheel in each pair of mutually engaging gear wheels on the intermediate shaft and the main shaft being mounted rotatably on its shaft and being lockable on its shaft by engaging means, and also operating means which interact with the engaging means and are controlled by a control unit depending on signals fed into the control unit representing various engine and vehicle data which comprise at least engine speed, vehicle speed and throttle pedal position.

Drive means of this type with what are known as automated multi-stage gearboxes have become increasingly common. Automatic gearboxes of this type, what are known as automated multi-stage gearboxes, have become increasingly common in heavy-duty vehicles as microcomputer technology has developed further and made it possible to use a control computer and a number of actuators, for example servo motors, to precision-regulate engine speed, engagement and disengagement of a disk clutch between the engine and the gearbox and also the engaging means of the gearbox in relation to one another, so that soft shifting is always obtained at the correct engine speed. The advantage of this type of automatic gearbox compared with a conventional automatic gearbox constructed with planetary gear stages and with a hydrodynamic torque converter on the input side is, especially as far as use in heavy-duty vehicles is concerned, that on the one hand it is simpler and more robust and can be produced at a considerably lower cost than the conventional automatic gearbox, and on the other hand it has greater efficiency, which means that lower fuel consumption is possible.

The automatic gearbox constructed from planetary gears usually has one-way engaging means between the planetary gear stages, which, when the engine is driving in the automatic transmission position, lock for torque transmission from the engine to the driving wheels but, when torque transmission takes place in the opposite direction, that is to say with zero throttle and the vehicle in motion, disengage and allow the vehicle to roll freely without engine braking, which results in lower fuel consumption by utilizing the motive energy of the vehicle than if the engine remains engaged and brakes. It has previously been possible to achieve the corresponding freewheel function in previously known automated multi-stage gearboxes only by manual disengagement of the disk clutch between the engine and the gearbox.

The object of the present invention is to produce a drive means of the type indicated in the introduction, with an engine and gearbox controlled by a control unit in such a manner that an automatic freewheel function corresponding to that in the conventional automatic gearbox with planetary gear stages and overrunning clutches can be obtained.

According to the invention, this is achieved by virtue of the fact that the control unit is arranged so as, in the event of input signals indicating vehicle speed together with zero throttle, first to control the engine speed toward zero torque transmission to the input shaft, and then to give an output signal to the operating means to put the currently engaged gear in the neutral position, and so as, when the throttle is subsequently opened, first to speed-control the engine to a suitable speed for engaging a gear appropriate to the speed of the vehicle, and then to give the operating means a signal to engage the gear.

By virtue of putting the engaged gear in neutral position, the drive line is uncoupled, so that the vehicle can roll freely without the braking effect which is otherwise obtained through friction losses and pump losses in the engine. In this way, the freewheel function is obtained without the use of special overrunning clutches.

In a development of the drive means according to the invention, in order to prevent a possible engine stoppage at the same time as the freewheel function is activated resulting in various servos, for example the steering servo and the brake servo, ceasing to function by virtue of the fact that the servo pumps stop simultaneously with the engine, the crankshaft of the engine can be driven by an electric machine speed-controlled by the control unit. In this connection, the control unit is arranged so as—on receiving signals indicating zero engine speed and a given vehicle speed at the same time as the gearbox is disengaged—first to give a signal to the electric machine to speed-control the engine to a speed suitable for engaging a gear, and then to give the operating means a signal to engage the gear.

The invention is described in greater detail with reference to illustrative embodiments shown in the accompanying drawings, in which

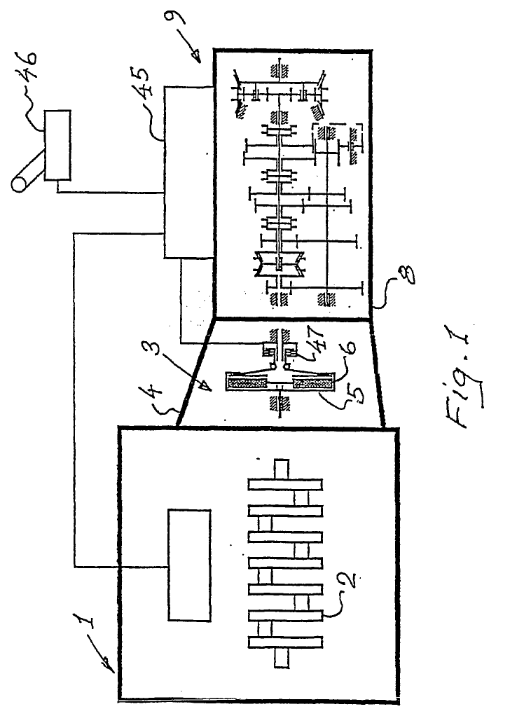

FIG. 1 shows a diagrammatic representation of a drive means according to the invention, and

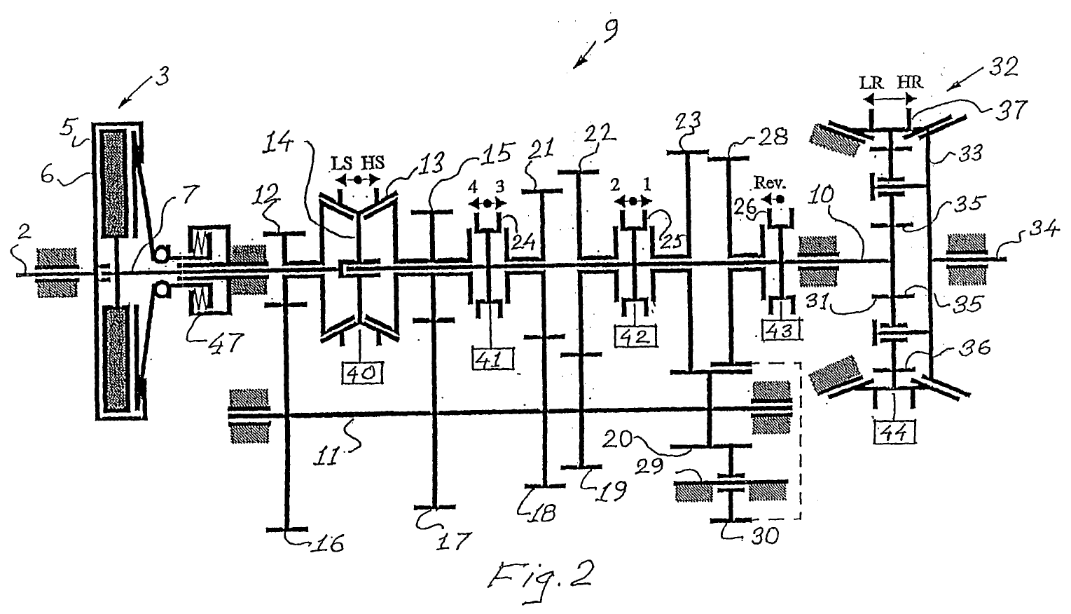

FIG. 2 shows the clutch and gearbox in FIG. 1 on enlarged scale.

In FIG. 1, reference number 1 designates a six-cylinder internal combustion engine, for example a diesel engine, the crankshaft 2 of which is coupled to a single-plate dry disk clutch which is designated generally by reference number 3 and is enclosed in a clutch case 4. The crankshaft 2 is connected non-rotatably to the clutch housing 5 of the clutch 3, while its disk plate 6 is connected non-rotatably to an input shaft 7 which is mounted rotatably in the casing 8 of a gearbox designated generally by reference number 9. A main shaft 10 and an intermediate shaft 11 are mounted rotatably in the casing 8. Connected between the crankshaft 2 of the engine and the clutch 3 is an electric machine 50, which is an integrated starter motor and generator, which can therefore be operated either as a motor in order to drive the crankshaft 2 of the internal combustion engine or, driven by the crankshaft of the engine, as a generator in order to generate electric power.

As can be seen most clearly from FIG. 2, a gear wheel 12 is mounted rotatably on the input shaft 7 and is lockable on the shaft by means of an engaging sleeve 13 which is provided with synchronizing means and is mounted non-rotatably but axially displaceably on a hub 14 connected non-rotatably to the input shaft 7. By means of the engaging sleeve 13, a gear wheel 15 mounted rotatably on the main shaft 10 is also lockable relative to the input shaft 7. With the engaging sleeve 13 in a central position, both gear wheels 12 and 15 are disengaged from their shafts 7 and, respectively, 10. The gear wheels 12 and 15 engage with gear wheels 16 and, respectively, 17 which are connected non-rotatably to the intermediate shaft 11. Arranged in a rotationally fixed manner on the intermediate shaft 11 are further gear wheels 18, 19 and 20 which engage with gear wheels 21, 22 and, respectively, 23 which are mounted rotatably on the main shaft 10 and are lockable on the main shaft by means of engaging sleeves 24 and, respectively, 25 which, in the illustrative embodiment shown, do not have synchronizing arrangements. A further gear wheel 28 is mounted rotatably on the main shaft 10 and engages with an intermediate gear wheel 30 which is mounted rotatably on a separate shaft 29 and engages in turn with the intermediate shaft gear wheel 20. The gear wheel 28 is lockable on its shaft by means of an engaging sleeve 26.

The gear wheel pairs 12, 16 and 15, 17 and also the engaging sleeve 13 form a split gearing with a low gear stage LS and a high gear stage HS. The gear wheel pair 15, 17 also forms, together with the gear wheel pairs 21, 18, 22, 19, 23, 20 and 28, 30, a basic gearbox with four forward gears and one reverse gear. Arranged in a rotationally fixed manner on the output end of the main shaft is a gear wheel 31 which forms the sun gear in a two-stage range gear of the planetary type designated by reference number 32, the planet wheel carrier 33 of which is connected in a rotationally fixed manner to a shaft 34 which forms the output shaft of the gearbox. The planet wheels 35 of the range gear 32 engage with a ring gear 36 which, by means of an engaging sleeve 37, is lockable relative to the gearbox casing 8 for low range LR and relative to the planet wheel carrier 33 for high range HR. The engaging sleeves 13, 24, 25, 26 and 37 are displaceable as shown by the arrows in FIG. 2, the gear stages shown next to the arrows being obtained. The displacement is brought about by servo devices 40, 41, 42, 43 and 44 which are indicated diagrammatically in FIG. 2 and may be pneumatically operated piston/cylinder arrangements of the type used in a gearbox of the type described above, which is marketed under the name Geartronic®.

The servo devices 40, 41, 42, 43 and 44 are controlled by an electronic control unit 45 (FIG. 1), comprising a microcomputer, depending on signals fed into the control unit representing the various engine and vehicle data which comprise at least engine speed, vehicle speed, throttle pedal position and, in this case, engine brake on/off, when an electronic gear selector 46 coupled to the control unit 45 is in its automatic transmission position. When the selector is in the position for manual shifting, shifting is effected via the gear selector 46 at the command of the driver. The control unit 45 also controls fuel injection, that is to say the engine speed, depending on the throttle pedal position, and also the air supply to a pneumatic piston/cylinder arrangement 47, by means of which the clutch 3 is disengaged.

According to the invention, the control unit 45 is programmed so that the freewheel function is activated when the driver or the cruise control while underway requests neither any fuel (zero throttle) nor activation of any engine brake, for example an exhaust gas pressure regulator or compression brake. This is effected by the control unit 45 first controlling the engine speed, so that no torque is transmitted between the input shaft 7 and the main shaft 10 of the gearbox. The control unit 45 then gives a signal to the servo device 40 to put the engaging sleeve in neutral position, after which the engine is controlled to idling speed. The drive line is then uncoupled, and the vehicle can roll freely. By disengaging a split gearing, the freewheel function is obtained by disengaging one and the same gear irrespective of which gear is engaged in the basic gearbox.

The control unit 45 is programmed to deactivate the freewheel function when the driver requests fuel with the throttle pedal or the cruise control or requests engine braking by, for example, activating an exhaust gas brake or compression brake. In this connection, the control unit first regulates the engine speed in toward a speed which makes displacement of the engaging sleeve 13 into its previous engagement position possible. The drive line is then coupled together, and driving or engine braking is possible again.

Also programmed into the control unit is a safety function in the event that the engine should stop when the freewheel function is activated, which involves the control unit 45 then first giving a signal to the electric machine 50 to speed-control the engine to a speed which makes it possible to displace the engaging sleeve 13 located in the neutral position into its previous engagement position. After engagement of the gear, the engine is driven by the vehicle and any auxiliary sets, such as servo pumps and engine brakes, normally driven by the engine are then driven by the vehicle via the engine.

The invention has been described above with reference to an embodiment, in which the freewheel function is achieved by disengaging one and the same gear, namely a split gearing, irrespective of which gear is engaged in the basic gearbox, when free-rolling of the vehicle is desired. Within the scope of the invention, it is of course possible to conceive of disengaging the currently engaged gear in a gearbox without split gearing.

1. Drive means for motor vehicles, comprising an internal combustion engine (1) and, connected to the crankshaft (2) of the engine via a clutch (3), an input shaft (7) of a multi-stage gearbox (9) which has at least one intermediate shaft (11) which is mounted in a casing and has at least one gear wheel (16, 18) in engagement with a gear wheel (12, 15) on the input shaft, a main shaft (10), mounted in the casing, with gear wheels (15, 21, 22, 23) which engage with gear wheels (18, 19, 20) on the intermediate shaft, at least one gear wheel in each pair of mutually engaging gear wheels on the intermediate shaft and the main shaft being mounted rotatably on its shaft and being lockable on its shaft by engaging means (13, 24, 25), and also operating means (40, 41, 42) which interact with the engaging means and are controlled by a control unit (45) depending on signals fed into the control unit representing various engine and vehicle data which comprise at least engine speed, vehicle speed and throttle pedal position, characterized in that the control unit (45) is arranged so as, in the event of input signals indicating vehicle speed and zero throttle, first to control the engine speed toward zero torque transmission to the input shaft (7), and then to give an output signal to the operating means (40, 41, 42) to put the currently engaged gear in the neutral position, and so as, when the throttle is subsequently opened, first to speed-control the engine (1) to a suitable speed for engaging a gear appropriate to the speed of the vehicle, and then to give the operating means a signal to engage the gear.

2. Drive means as claimed in claim 1, comprising an engine with engine braking means in order to increase the braking effect of the engine, characterized in that the control unit (45) is arranged so as, in the event of input signals representing zero throttle and engine braking means switched off, first to control the engine torque toward zero torque transmission to the input shaft (7), and then to give an output signal to the operating means (40, 41, 42) to put the currently engaged gear in the neutral position.

3. Drive means as claimed in claim 1 or 2, characterized in that the disengageable gear wheel (21, 22, 23) in each pair of mutually engaging gear wheels on the intermediate shaft (11) and the main shaft (10) is lockable on its shaft by engaging means (24, 25) which do not have a synchronizing function.

4. Drive means as claimed in any one of claims 1-3, characterized in that the crankshaft (2) of the engine can be driven by an electric machine (50) speed-controlled by the control unit (45), and in that the control unit is arranged so as—on receiving input signals representing zero engine speed and a given vehicle speed at the same time as said gear is disengaged—first to give a signal to the electric machine to speed-control the engine to a speed suitable for engaging a gear, and then to give the operating means (40, 41, 42) a signal to engage the gear.

5. Drive means as claimed in claim 4, characterized in that the electric machine (50) is an integrated starter motor and generator which is connected between the crankshaft (2) of the internal combustion engine and the clutch (3) connected to the input shaft of the gearbox.

6. Drive means as claimed in any one of claims 1-5, characterized in that the main shaft (10) bears in a rotationally fixed manner the sun gear (35) in a planetary gear, the planet wheel carrier (33) of which is connected to an output shaft (34) mounted in the casing.
